(19) United States
(12) Patent Application Publication
(10) Pub. No.: US 2023/0043366 A1
(43) Pub. Date: Feb. 9, 2023

(54) Wireless Earring Assembly

(71) Applicant: Patrick Jones, Greenville, SC (US)

(72) Inventor: Patrick Jones, Greenville, SC (US)

(21) Appl. No.: 17/393,019

(22) Filed: Aug. 3, 2021

(51) Int. Cl. H04R 1/10; A44C 7/00

(52) U.S. Cl. CPC H04R 1/1008; A44C 7/001; H04R 1/1025; H04R 2420/07

(57) ABSTRACT

A wireless earring assembly for discretely streaming audio into a user's ears includes a pair of earrings that each includes an ornament, a stud extending away from the ornament and a retainer that is slidable onto the stud. A pair of audio units is each integrated into the ornament of a respective one of the earrings. Each of the audio units is in wireless communication with an audio source such that each of the audio units receives an audio signal from the audio source. Additionally, each of the audio units has sound emitting capabilities to emit audible sounds from the audio signal toward the user's ear.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### Field of the Invention

The disclosure relates to earring devices and more particularly pertains to a new earring device for discretely streaming audio into a user's ears. The device includes a pair of audio units that are each integrated into a respective earring. Each of the audio units can be wirelessly connected to a personal electronic device and each of the audio units can emit audible sound.

### Description of Related Art Including Information Disclosed Under 37 CFR 1.97 And 1.98

The prior art relates to earring devices including a variety of earphone devices that are in wireless communication with an audio source. The prior art discloses an audio device that can be worn in a piercing of a user's ear. The prior art discloses an audio device that includes a speaker which is attached to an earring stud such that the speaker is exposed on a user's earlobe when the earring stud is extended through a piercing in the earlobe.

### BRIEF SUMMARY OF THE INVENTION

An embodiment of the disclosure meets the needs presented above by generally comprising a pair of earrings that each includes an ornament, a stud extending away from the ornament and a retainer that is slidable onto the stud. A pair of audio units is each integrated into the ornament of a respective one of the earrings. Each of the audio units is in wireless communication with an audio source such that each of the audio units receives an audio signal from the audio source. Additionally, each of the audio units has sound emitting capabilities to emit audible sounds from the audio signal toward the user's ear.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWINGS

The disclosure will be better understood and objects other than those set forth above will become apparent when consideration is given to the following detailed description thereof. Such description makes reference to the annexed drawings wherein:

FIG. 1 is a perspective view of a wireless earring assembly according to an embodiment of the disclosure.

FIG. 2 is a front perspective view of an earring of an embodiment of the disclosure.

FIG. 3 is a back perspective view of an earring of an embodiment of the disclosure.

FIG. 4 is a top view of an earring of an embodiment of the disclosure.

FIG. 5 is a cross sectional view taken along line 5-5 of FIG. 4 of an embodiment of the disclosure.

FIG. 6 is a schematic view of an embodiment of the disclosure.

FIG. 7 is a perspective in-use view of an embodiment of the disclosure.

### J) DETAILED DESCRIPTION OF THE INVENTION

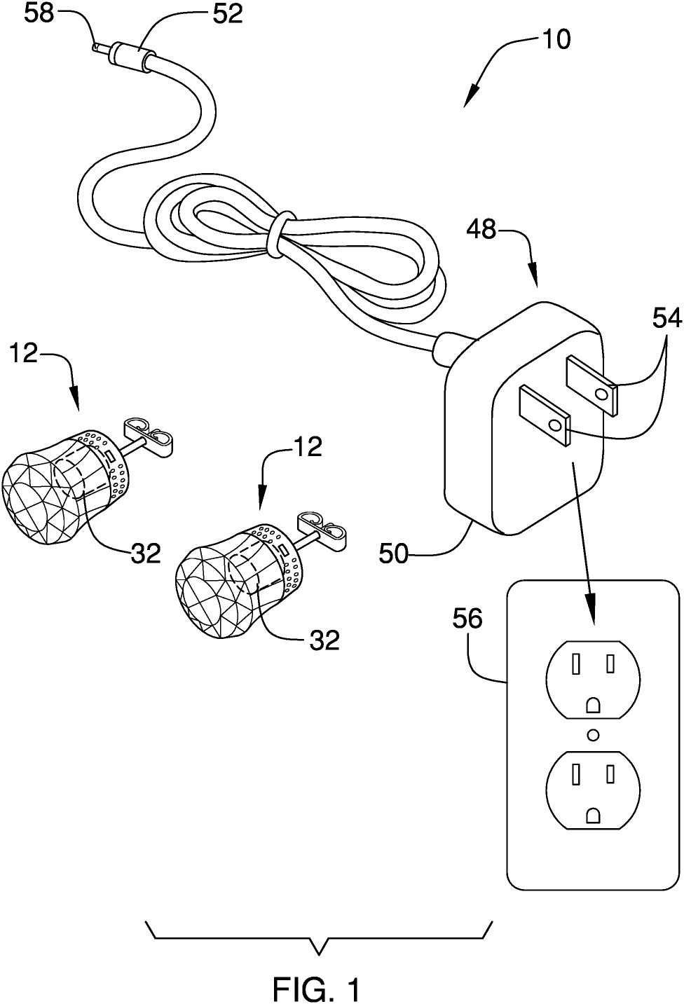

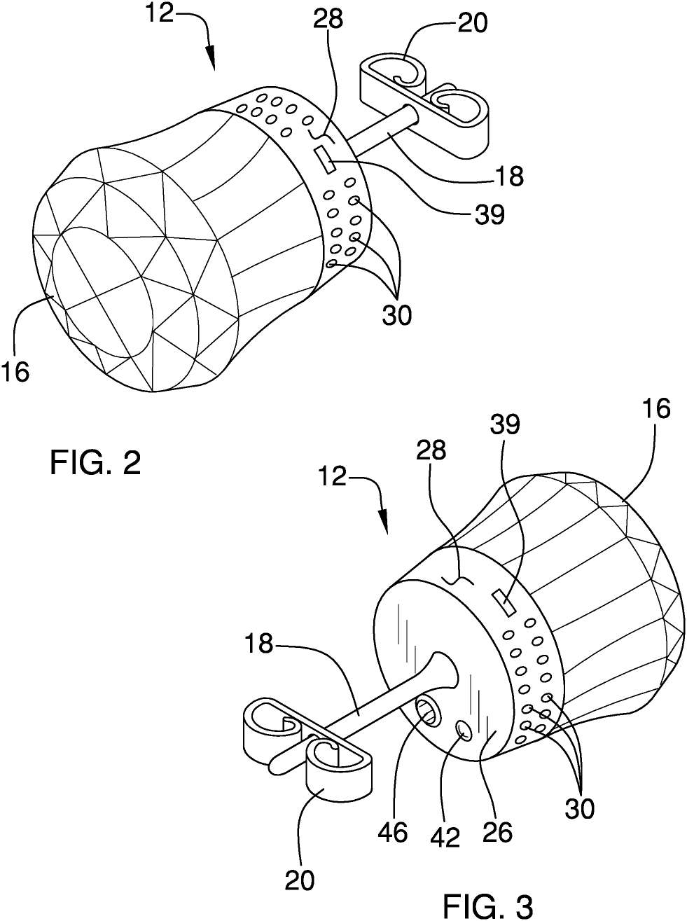

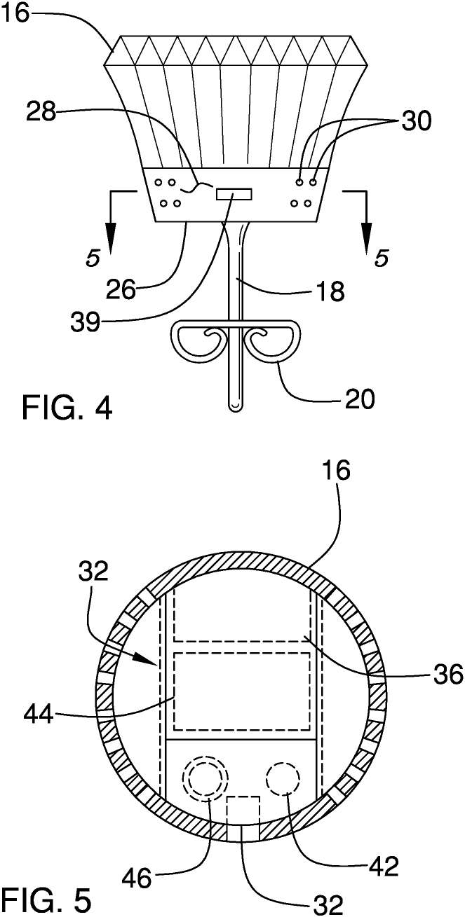

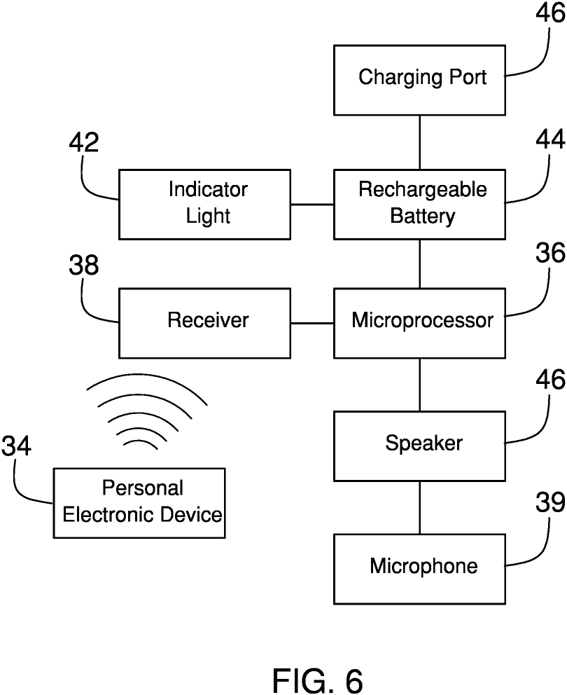

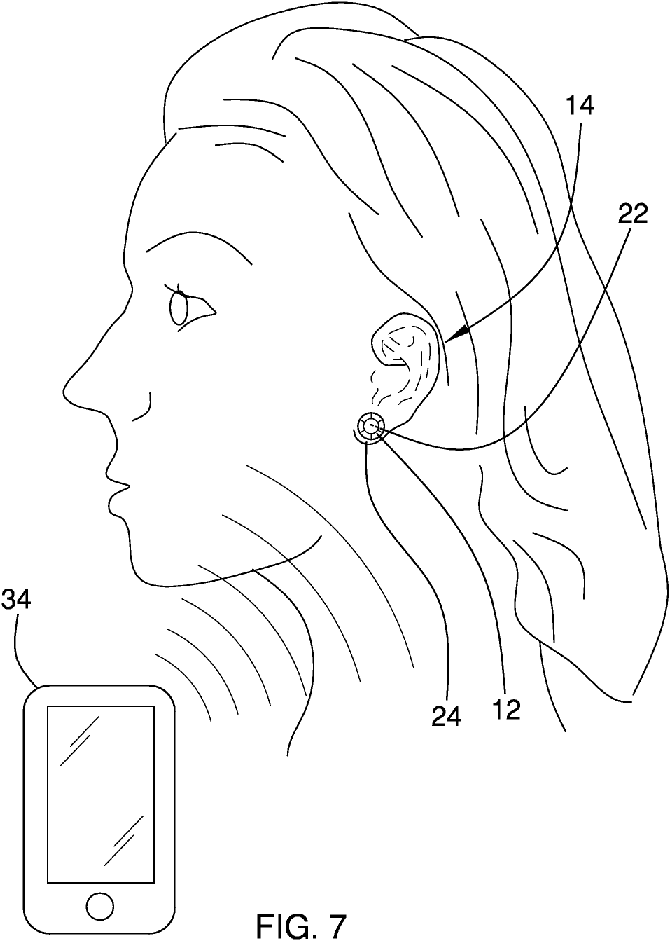

With reference now to the drawings, and in particular to FIGS. 1 through 7 thereof, a new earring device embodying the principles and concepts of an embodiment of the disclosure and generally designated by the reference numeral 10 will be described.

As best illustrated in FIGS. 1 through 7, the wireless earring assembly 10 generally comprises a pair of earrings 12 that can be worn on a user's ears 14. Each of the earrings 12 includes an ornament 16, a stud 18 extending away from the ornament 16 and a retainer 20 that is slidable onto the stud 18. The stud 18 can be extended through a piercing 22 in a user's earlobe 24 having the ornament 16 being exposed on the user's earlobe 24. The ornament 16 may comprise a gemstone, a metallic object or any other kind of ornament commonly associated with earrings. The ornament 16 has a rear side 26 and an outer surface 28, and the stud 18 extends away from the rear side 26. The outer surface 28 of the ornament 16 has a plurality of sound holes 30 each extending into an interior of the ornament 16, and each of the sound holes 30 is positioned adjacent to the rear side 26. Additionally, the sound holes 30 are spaced apart from each other and are distributed around a partial circumference of the outer surface 28.

A pair of audio units 32 is provided and each of the audio units 32 is integrated into the ornament 16 of a respective one of the earrings 12. Each of the audio units 32 is in wireless communication with an audio source 34 such that each of the audio units 32 receives an audio signal from the audio source 34. Additionally, each of the audio units 32 has sound emitting capabilities to emit audible sounds from the audio signal toward the user's ear 14. The audio source 34 may be a smart phone, or other personal electronic device, that has wireless communication capabilities.

Each of the audio units 32 comprises a control circuit 36 that is integrated into the ornament 16 of the respective earring 12. Each of the audio units 32 includes a receiver 38 that is integrated into the ornament 16 of the respective earring 12. The receiver 38 is electrically coupled to the control circuit 36 and the receiver 38 is in wireless communication with the audio source 34 thereby facilitating the receiver 38 to receive the audio signal. The receiver 38 may comprise a radio frequency receiver or the like and the receiver 38 may employ Bluetooth communication protocols. Each of the audio units 32 includes a microphone 39 that is integrated into the ornament 16 of the respective earring 12 for capturing audible sounds. The microphone 39 is electrically coupled to the control circuit 36 such that the microphone 39 facilitates the user to make and receive phone calls via the receiver 38. Additionally, the microphone 39 may comprise an electronic microphone or the like.

Each of the audio units 32 includes a speaker 40 that is positioned within the ornament 16 of the respective earring 12 and the speaker 40 is electrically coupled to the control circuit 36 such that the speaker 40 receives the audio signal. The speaker 40 is aligned with the plurality of sound holes 30 in the outer surface 28 of the ornament 16 to emit audible sounds through the sound holes 30. In this way the user can listen to music received from the audio source 34. Additionally, the speaker 40 may comprise an electronic speaker of any conventional design.

A light emitter 42 is coupled to the rear surface of the respective earring 12 and the light emitter 42 is electrically coupled to the control circuit 36. The light emitter 42 is turned on when the receiver 38 is placed into communication with the audio source 34 to visually alert the user that the receiver 38 is communicating with the audio source 34. The light emitter 42 may comprise a light emitting diode or other type of electronic light emitter.

A rechargeable battery 44 is integrated into the ornament 16 of the respective earring 12 and the rechargeable battery 44 is electrically coupled to the control circuit 36. A charge port 46 is recessed into the rear side 26 of the ornament 16 of the respective earring 12 and the charge port 46 is electrically coupled to the rechargeable battery 44. A charger 48 is included that is pluggable into the audio units 32 for charging the audio units 32, and the charger 48 includes a first plug 50 and a second plug 52. The first plug 50 includes a pair of prongs 54 that can be plugged into a power source 56 comprising a female electrical outlet. The second plug 52 comprises a single prong 58 that is insertable into the charge port 46 for charging the rechargeable battery 44.

In use, the earrings 12 are worn in the traditional convention of wearing earrings and the personal electronic device is synched with the receiver 38 in each of the audio units 32. In this way the speaker 40 in each of the audio units 32 can emit music, for example, that is streamed from the personal electronic device. Additionally, the earrings 12 enhance the user's appearance in the traditional convention of wearing earrings. In this way the user can listing to streamed music in a discrete manner as compared to wearing earbuds or other more bulky headphones. The charger 48 can be plugged into the charge port 46 in each of the earrings 12 for charging the rechargeable battery 44 in each of the earrings 12.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word "comprising" is used in its non-limiting sense to mean that items following the word are included, but items not specifically mentioned are not excluded. A reference to an element by the indefinite article "a" does not exclude the possibility that more than one of the element is present, unless the context clearly requires that there be only one of the elements.

1. A wireless earring assembly for streaming audio from earrings being worn, said assembly comprising:
a pair of earrings, each of said earrings including an ornament, a stud extending away from said ornament, and a retainer being slidable onto said stud wherein said stud is configured to be extended through a piercing in a user's earlobe having said ornament being exposed on the user's earlobe;
a pair of audio units, each of said audio units being integrated into said ornament of a respective one of said earrings, each of said audio units being in wireless communication with an audio source such that each of said audio units receives an audio signal from the audio source, each of said audio units having sound emitting capabilities wherein each of said audio units is configured to emit audible sounds from the audio signal toward the user's ear, wherein each of said audio units includes a light emitter being coupled to said rear side of said respective earring, said┊light emitter being configured to turn on when said audio unit is placed into communication with the audio source wherein said light emitter is configured to visually alert the user that said audio unit is communicating with the audio source. said light emitter being configured to be obscured by the user's earlobe when said stud extends through the piercing in the user's earlobe; and
a charger being pluggable into said audio units for charging said audio units for charging the audio units.

2. The assembly according to claim 1, wherein:
said ornament has a rear side and an outer surface, said stud extending away from said rear side, said outer surface of said ornament having a plurality of sound holes each extending into an interior of said ornament, each of said sound holes being positioned adjacent to said rear side, said sound holes being spaced apart from each other and being distributed around a partial circumference of said outer surface; and
each of said audio units comprises a speaker being positioned within said ornament of said respective earring, said speaker being aligned with said plurality of sound holes in said outer surface of said ornament wherein said speaker is configured to emit audible sounds through said sound holes thereby facilitating the user to listen to music received from the audio source.

3. The assembly according to claim 1, wherein each of said audio units comprises:
a control circuit being integrated into said ornament of said respective earring;
a receiver being integrated into said ornament of said respective earring, said receiver being electrically coupled to said control circuit, said receiver being in wireless communication with the audio source thereby facilitating said receiver to receive the audio signal; and
a speaker being integrated into said ornament of said respective earring, said speaker being electrically coupled to said control circuit such that said speaker receives the audio signal.

4. The assembly according to claim 3, wherein earring, said light emitter is electrically coupled to said control circuit, said light emitter being turned on when said receiver is placed into communication with the audio source wherein said light emitter is configured to visually alert the user that said receiver is communicating with the audio source.

5. The assembly according to claim 3, wherein each of said audio units includes:
a rechargeable battery being integrated into said ornament of said respective earring, said rechargeable battery being electrically coupled to said control circuit; and
a charge port being recessed into said rear side of said ornament of said respective earring, said charge port being electrically coupled to said rechargeable battery.

6. A wireless earring assembly for streaming audio from earrings being worn, said assembly comprising:
a pair of earrings, each of said earrings including an ornament, a stud extending away from said ornament and a retainer being slidable onto said stud wherein said stud is configured to be extended through a piercing in a user's earlobe having said ornament being exposed on the user's earlobe, said ornament having a rear side and an outer surface, said stud extending away from said rear side, said outer surface of said ornament having a plurality of sound holes each extending into an interior of said ornament, each of said sound holes being positioned adjacent to said rear side, said sound holes being spaced apart from each other and being distributed around a partial circumference of said outer surface;
a pair of audio units, each of said audio units being integrated into said ornament of a respective one of said earrings, each of said audio units being in wireless communication with an audio source such that each of said audio units receives an audio signal from the audio source, each of said audio units having sound emitting capabilities wherein each of said audio units is configured to emit audible sounds from the audio signal toward the user's ear, each of said audio units comprising:
a control circuit being integrated into said ornament of said respective earring;
a receiver being integrated into said ornament of said respective earring, said receiver being electrically coupled to said control circuit, said receiver being in wireless communication with the audio source thereby facilitating said receiver to receive the audio signal;
a speaker being positioned within said ornament of said respective earring, said speaker being electrically coupled to said control circuit such that said speaker receives the audio signal, said speaker being aligned with said plurality of sound holes in said outer surface of said ornament wherein said speaker is configured to emit audible sounds through said sound holes thereby facilitating the user to listen to music received from the audio source;
a light emitter being coupled to said rear side of said respective earring, said light emitter being electrically coupled to said control circuit, said light emitter being turned on when said receiver is placed into communication with the audio source wherein said light emitter is configured to visually alert the user that said receiver is communicating with the audio source, said light emitter being configured to be obscured by the user's earlobe when said stud extends through the piercing in the user's earlobe:
a rechargeable battery being integrated into said ornament of said respective earring, said rechargeable battery being electrically coupled to said control circuit; and
a charge port being recessed into said rear side said ornament of said respective earring, said charge port being electrically coupled to said rechargeable battery; and
a charger being pluggable into said audio units for charging said audio units, said charger including a first plug and a second plug, said first plug including a pair of prongs wherein said first plug is configured to be plugged into a power source comprising a female electrical outlet, said second plug comprising a single prong being insertable into said charge port wherein said rechargeable battery is configured to be charged with the power source.

7. A wireless earring system for streaming audio from earrings being worn, said system comprising:
a personal electronic device having wireless communication capabilities;
a pair of earrings, each of said earrings including an ornament, a stud extending away from said ornament, and a retainer being slidable onto said stud wherein said stud is configured to be extended through a piercing in a user's earlobe having said ornament being exposed on the user's earlobe, said ornament having a rear side and an outer surface, said stud extending away from said rear side, said outer surface of said ornament having a plurality of sound holes each extending into an interior of said ornament, each of said sound holes being positioned adjacent to said rear side, said sound holes being spaced apart from each other and being distributed around a partial circumference of said outer surface;
a pair of audio units, each of said audio units being integrated into said ornament of a respective one of said earrings, each of said audio units being in wireless communication with said personal electronic device such that each of said audio units receives an audio signal from said personal electronic device, each of said audio units having sound emitting capabilities wherein each of said audio units is configured to emit audible sounds from the audio signal toward the user's ear, each of said audio units comprising:
a control circuit being integrated into said ornament of said respective earring;
a receiver being integrated into said ornament of said respective earring, said receiver being electrically coupled to said control circuit, said receiver being in wireless communication with said personal electronic device thereby facilitating said receiver to receive the audio signal;
a speaker being positioned within said ornament of said respective earring, said speaker being electrically coupled to said control circuit such that said speaker receives the audio signal, said speaker being aligned with said plurality of sound holes in said outer surface of said ornament wherein said speaker is configured to emit audible sounds through said sound holes thereby facilitating the user to listen to music received from said personal electronic device;
a light emitter being coupled to said rear side of said respective earring, said light emitter being electrically coupled to said control circuit, said light emitter being turned on when said receiver is placed into communication with the audio source wherein said light emitter is configured to visually alert the user that said receiver is communicating with said personal electronic device, said light emitter being configured to be obscured by the user's earlobe when said stud extends through the piercing in the user's earlobe:
a rechargeable battery being integrated into said ornament of said respective earring, said rechargeable battery being electrically coupled to said control circuit; and
a charge port being recessed into said rear side of said ornament of said respective earring, said charge port being electrically coupled to said rechargeable battery; and
a charger being pluggable into said audio units for charging said audio units, said charger including a first plug and a second plug, said first plug including a pair of prongs wherein said first plug is configured to be plugged into a power source comprising a female electrical outlet, said second plug comprising a single prong being insertable into said charge port wherein said rechargeable battery is configured to be charged with the power source.
